(19) United States
(12) Patent Application Publication
(10) Pub. No.: US 2025/0382230 A1
(43) Pub. Date: Dec. 18, 2025

(54) Self-Hardening Slurry Composition and Method

(71) Applicant: Liquid Earth Support Inc., McLean, VA (US)

(72) Inventor: Gilbert R. Tallard, McLean, VA (US)

(21) Appl. No.: 18/745,545

(22) Filed: Jun. 17, 2024

(51) Int. Cl. C04B 28/04; C04B 14/08; C04B 14/10; C04B 14/16; C04B 14/18; C04B 40/00; C04B 111/27

(52) U.S. Cl. CPC C04B 28/04; C04B 14/08; C04B 14/104; C04B 14/106; C04B 14/16; C04B 14/18; C04B 40/0042; C04B 2111/27

(57) ABSTRACT

A self-hardening slurry and method is provided that can be used to prepare geotechnical construction materials with suitable properties so as to be useful in the construction of underground water cutoffs and other water barriers designed to achieve the required hydraulic conductivity, e.g., about 10⁻⁶ or 10⁻⁷ cm per second. The slurry composition of the present disclosure relates to a dry mixture that is added to water to provide a self-hardening slurry (SHS) composition that obtains a significant reduction in the amount of Portland cement (or OPC). The SHS is formed using high-silica materials to replace significant amounts of OPC which will lower overall costs and be more acceptable under regulations governing such structures. The slurry composition can be used to form products like slurry walls that will provide advantageous engineering properties with regard to strength and hydraulic conductivity or permeability at lower cost.

### FIELD

The field of the present application is directed to self-hardening slurries in general, and more specifically to a geotechnical construction material that uses mixtures combining water, a clay generally used as a suspending agent and a binder, typically a Portland cement or a blend of Portland cement and blast furnace slag cement to form a stable fluid slurry that sets after a certain time. More specifically, the present disclosure relates to a self-hardening slurry (or SHS) composition and method that obtains a significant reduction in the amount of Portland cement that is used. Such a self-hardening slurry can harden once in place where desired, and structures implementing this material can include hydraulic barriers or cutoff walls constructed by trenching, soil mixing, jet grouting, permeation grouting, vibrating beam thin walls, and cavity backfilling. The present self-hardening slurries as described herein provide the advantageous engineering properties of strength and hydraulic conductivity or permeability and thus are suitable in particular for the construction of underground water cutoffs and other water barriers designed to achieve a hydraulic conductivity of about 10⁻⁶ or 10⁻⁷ cm per second.

### BACKGROUND

The present disclosure relates to the field of self-hardening slurries which reflects a technology that has been around for over 60 years. Self-hardening slurries started as a stable suspension of natural clays (eventually Bentonite) and Ordinary Portland Cement (OPC) used originally to inject by permeation fairly coarse alluvium in dam foundations, and later as a support fluid to stabilize narrow trenches of any depth (slurry trenching), such fluid staying in place and setting to form the body of a hydraulic barrier such as a cutoff wall. This technique became known as cement-bentonite (CB) and practiced all over the world. After the creation of the US Environmental Protection Agency (EPA) in 1974 and the initiation of the Superfund remediation program, new standards were put in place and the engineering requirement for permeability of hydraulic barriers or cutoff walls for confining contaminated aquifers was (and still is) normally E 10⁻⁷ cm/sec.

A conventional CB trench to control clean water flow generally has a requirement for permeability of E 10⁻⁶ cm/sec, but this has been difficult to achieve. As a result, CB trenches were excluded from the hazardous waste remediation business and Superfund program. Next, in 1987, the present inventor obtained U.S. Pat. No. 4,726,713 in which a different clay (attapulgite) was used for suspension with the binder exclusively being a ground blast furnace slag cement (GBFSC), and the attapulgite clay had the particularity of acting as an activator for slag cement. This SHS was able to achieve a much lower coefficient of permeability in the range of E 10⁻⁸ to 10⁻⁹ cm/sec., and this enabled the one step slurry trenching method using an SHS in the hazardous waste remediation business.

Other competitive forms of these materials arose including an SHS using bentonite as the clay and the binder being mainly a slag cement, but this also included a quantity of OPC (up to 25%) to act mainly as the slag activator. Slag cement became the binder of choice technically but also economically since a lesser amount than with OPC was required and, being a waste product, sold cheaper than OPC, and became a desirable substitute. With much lower permeability and major strength gain on a pound-to-pound basis with OPC, slag cement became the binder of choice in this industry.

Ground blast furnace slag cement is derived from a waste product produced by the traditional pig iron manufacturing (Bessemer Process). As this industry is a major source of CO2 emissions, a worldwide modernization has recently been undertaken. Consequently, an increasing reduction of slag cement is occurring with an eventual disappearance in the coming years, and only one steel plant in the US produces domestic slag cement (US Steel, South Chicago). The bulk of slag cement used in the US is now of foreign origin, becoming scarce and gradually more expensive. It is becoming reserved for contract customers such as the ready-mix concrete or pre-cast concrete industries. Spot customers like specialty geotechnical contractors are experiencing increasing difficulties in procuring slag cement, the distribution of which is uneven throughout the country, contrary to widely available Portland cement produced more locally.

In view of this trend, it is understood that in the coming years, SHS without slag cement will be needed when only the old CB would be the only possibility with its performance limitations and high CO2 emission factor using pure OPC as binder. Reading about the evolution of concrete technology related to the manufacture of OPC, the existence of an imbalance of the calcium/silica ratio in some hydrates formed and typical of strength gain during the OPC hydration has pushed researchers to examine the possible modifications of the manufacturing process to bring the Ca/Si ratio towards 1. By modifying the silica content of ingredients going into the cement kiln, substantial strength gain has been achieved. However, it has still been hard to develop a suitable SHS with the necessary properties that achieves lower amounts of OPC.

In concrete, the W/C ratio tends to be minimized for maximum strength and is in the range of 0.5 to 0.35. In SHSs typical W/C is in the range of 5 to 10, 10 to 20 times the water amount. The question was whether at such a level of dilution, the Ca/Si ratio modification would also produce improvements in SHS strength was tantalizing.

As a result, the present inventor recognized the unmet need of ultimately reducing the amount of OPC that may be used in an SHS yet still have the required properties including permeability as discussed above.

One possibility that had not been previously explored was the possibility of a mix obtained by substituting some of the OPC with a silica rich element; the aim being to lower the SHS mix carbon footprint while finding natural sources of siliceous soils materials having a natural low carbon footprint and being economical. Transportation is a significant cost representing often more than the value of the materials in the delivered price. This further directed the focus of overcoming the problems of the prior art by attempting to find a variety of materials that could be accessed within a reasonable distance.

Considering that SHSs are primarily used in one step trenching techniques for cutoff walls intercepting clean water in water barriers such as dams and levees, the hydraulic conductivity target is an E of 10⁻⁶ cm/sec. To achieve this level of watertightness, a conventional CB mix requires a minimum of 22% of OPC by weight of water; the bentonite content being typically in the range of about 4%.

It will thus become very important in the coming years to provide self-hardening slurries that can substantially reduce the amount of Portland Cement used and still maintain the necessary properties of strength and hydraulic permeability that allow it to be used as a water barrier in construction applications such as trenching, soil mixing, jet grouting, permeation grouting, vibrating beam thin walls, and cavity backfilling.

### SUMMARY

In light of the need to develop suitable self-hardening slurries that can be used as a geotechnical construction material with suitable properties to be used for the construction of underground water cutoffs and other water barriers designed to achieve a hydraulic conductivity of about 10⁻⁶ or 10⁻⁷ cm per second, the present disclosure relates to a self-hardening slurry and/or a dry mixture that is added to water to provide a self-hardening slurry (SHS) composition that obtains a significant reduction in the amount of Portland cement that is used, namely at least a 50% or higher in the amount of OPC used. Such a self-hardening slurry can harden once in place where desired, and structures implementing this material can include hydraulic barriers or cutoff walls constructed by trenching, soil mixing, jet grouting, permeation grouting, vibrating beam thin walls, and cavity backfilling. The present self-hardening slurries as described herein provide the advantageous engineering properties of strength and hydraulic conductivity or permeability and thus are suitable in particular for the construction of underground water cutoffs and other water barriers designed to achieve a hydraulic conductivity of about 10-6 to 10⁻⁷ cm per second, all while achieving significant reductions in the amount of Portland cement that needs to be used.

In certain embodiments of the present disclosure, the self-hardening slurry of the disclosure can obtain significant reductions of the OPC content in a CB mix, for example, wherein the OPC is reduced from its current minimal level of 22% down to 11% or lower, thus obtaining a reduction of 50% or higher in the OPC content. As described in more detail herein, the present composition and methods can provide replacement materials for significant amounts of the OPC that will be based on high-silica materials for use in constructing water barriers and other similar materials with the focus on obtaining materials readily available from local sources to once again lower the overall costs and make the materials more readily available where and when needed. In particular, the replacement materials will generally include those materials having a high silica (as SiO2) content, and such high-silica materials may include pumice, perlite ore, expanded pumice, diatomaceous earth, Red Lake earth, sodium and calcium bentonite, kaolin, attapulgite, and other similar materials. By referring to high-slice materials, it is generally meant that the silica content represents 50 to 95% of the mass of the material.

In certain exemplary embodiments, an aqueous self-hardening slurry is provided comprising (a) about 4-15% by weight of OPC; (b) about 2-15% by weight of a high-silica material wherein the silica content is in the range of 50-95% of the mass of said high-silica material; (c) about 2-12% by weight of bentonite; and (d) about 75-90% by weight of water. In other exemplary embodiments, an aqueous self-hardening slurry is provided comprising (a) about 5-12% by weight of OPC; (b) about 3-10% by weight of a high-silica material wherein the silica content is in the range of 50-95% of the mass of said high-silica material; (c) about 3-10% by weight of bentonite; and (d) about 75-90% by weight of water.

In certain exemplary embodiments, the aqueous self-hardening slurry of the disclosure includes a high silica material to replace 50% of the OPC or higher wherein the high-silica material is selected from the group consisting of pumice, perlite ore, expanded perlite, diatomaceous earth, Red Lake earth, bentonite, sodium bentonite, calcium bentonite, kaolin, and attapulgite. The silica of the high-silica material in the aqueous self-hardening slurry may be in any convention silica form such SiO2. In some exemplary embodiments, the amount of OPC in the self-hardening slurry is 11% or less by weight, and the self-hardening slurry may have a hydraulic conductivity of about 10⁻⁶ to 10⁻⁷ cm per second. In additional embodiments, the high-silica material will be exclusively bentonite.

There is also a benefit not to exclude certain sources of industrial waste or recycling activities, namely silica fume and powdered recycled glass, with regard to the materials for the slurry of the present disclosure. Both of these materials are essentially pure silica that may present local sourcing opportunities, and this would provide comparable results as the earth-sourced silica rich minerals as discussed above. Test results regarding the use of silica fume have been obtained and are included in the Table provided hereinbelow.

In other embodiments in accordance with the disclosure, a water barrier is provided that will comprising the aqueous self-hardening slurry as described herein. Such water barriers are well known in the industry and can take numerous forms such as a dam, a sluice, a cutoff wall, or any of a variety of other forms needed in order to provide a structure with suitable water barrier properties. The water barrier of the disclosure will generally have a permeability coefficient of less than 10⁻⁷ cm/sec.

In certain embodiments of the present disclosure, the aqueous self-hardening slurry will comprise (a) about 40-60 grams of bentonite per 1000 grams of water; (b) about 40 to 100 grams, or 50 to 90 grams, of a high-silica material per 1000 grams of water wherein the silica content is in the range of 50-95% of the mass of said high-silica material; and (c) about 75 to 125 grams, or about 100 to 120 grams of OPC per 1000 grams of water. The precise amount of the high-silica materials can be adjusted based on the level of OPC reduction needed, and in certain embodiments, the amount of the high-silica material will be about 50 to 90 grams per 1000 grams of water. As indicated above, such high-silica materials can comprise a number of suitable high-silica materials with a silica content of 50% or higher by mass, and these materials can be selected from the group consisting of pumice, perlite ore, expanded perlite, diatomaceous earth, Red Lake earth, bentonite, sodium bentonite, calcium bentonite, kaolin, and attapulgite. In certain embodiments, the goal is to achieve a 50% reduction in the amount of Portland cement, and as a result, the slurries of the disclosure will limit the total the total amount of OPC to about 11% or less. In each case, the slurries will maintain suitable water-barrier properties such that their hydraulic conductivity will be about 10⁻⁶ to 10⁻⁷ cm per second.

In additional embodiments of the disclosure, a dry blend mixture is provided which is capable of forming a self-hardening mass when reacted or combined with an aqueous component. In such cases, the dry blend mixture may be prepared comprising about 40-55% by weight of OPC, about 30-45% by weight of high silica materials wherein the silica content is in the range of 50-95% of the mass of said high-silica materials; and about 30-70% of bentonite. This dry blend mixture can then be turned into an aqueous self-hardening slurry when combined with water. Such a process of turning the dry blend mixture into the self-hardening slurry of the disclosure can be done in one steps, two steps, or multiple steps as described herein. In exemplary embodiments, the aqueous self-hardening slurry prepared from the dry blend mixture set forth herein will have an amount of OPC that is about 11% or less (by weight of water).

In additional embodiments of the disclosure, an aqueous self-hardening slurry is providing which comprises (a) about 4-15% by weight of OPC; (b) about 2-15% by weight of high-silica materials wherein the silica content is in the range of 50-95% of the mass of said high-silica materials; (c) about 2-12% by weight of bentonite; and (d) about 75-90% by weight of water. In another exemplary embodiment of the disclosure, an aqueous self-hardening slurry is providing which comprises (a) about 5-12% by weight of OPC; (b) about 3-10% by weight of high-silica materials wherein the silica content is in the range of 50-95% of the mass of said high-silica materials; (c) about 3-10% by weight of bentonite; and (d) about 75-90% by weight of water. Such slurries will have the permeability and water barrier properties as described herein, e.g., a hydraulic conductivity of about 10⁻⁶ to 10⁻⁷ cm per second.

As described herein, the self-hardening slurry if the disclosure is designed to achieve a significant reduction in the Portland cement content of traditional materials used in preparing water barriers, and such reduction can be 50% or more of the OPC content of prior art forms. In the traditional or baseline version of these prior forms, previous aqueous self-hardening slurries were prepared which included OPC, bentonite, and water, in some cases having OPC at a level of 22% or higher, and the self-hardening slurries of this disclosure provide an improvement wherein at least 50 percent of the OPC content is replaced with a high-silica material wherein the silica content is in the range of 50-95% of the mass of said high-silica material. Such an improvement provides a material with improved water barrier problems, but at lower costs, with improved efficiency, and without the environmental problems that might be caused by the prior art traditional structures having the higher emissions levels of OPC.

### DETAILED DESCRIPTION

As indicated herein, the disclosure relates to a self-hardening slurry with a reduced level of ordinary Portland Cement (OPC). The new slurry of the invention obtains a significant reduction of OPC content, for example from the normal amount of 22% down to about to 11% or lower in certain applications. The method and composition described in this disclosure generally replaces OPC with materials having a high silica (SiO₂) content, and such materials can include pumice, perlite ore or expanded, diatomaceous earth, Red Lake earth, sodium and calcium bentonite, kaolin, attapulgite, and bentonite, as described further herein.

As described further herein, the material of the present disclosure is a dry mixture to which water is added in order to obtain a self-hardening slurry for reducing the level of Portland cement by replacing it with high-silica materials. The main application of the self-hardening slurry will be for providing water barriers installed in the ground to intercept horizontal ground water flow wherein water resistance is the most important parameter. As indicated above, previous alternative materials in this field found it difficult to obtain sufficient hydraulic permeability to be used as a water barrier, and related more to concrete materials which are focused primarily on strength such as for a structural wall but not for their permeability properties so as to be useable as a water barrier. The materials of the present disclosure are directed to those self-hardening slurries that use high-silica materials as described herein to replace Portland cement, but which obtain superior hydraulic properties so they can be used in the construction of underground water cutoffs and other water barriers designed to achieve a hydraulic conductivity of about 10⁻⁶ or 10⁻⁷ cm per second.

As indicated above, the previous SHS materials using high slag cement materials will need to be phased out in the near future, but current alternative materials such as the old CB would not be suitable in light of its performance limitations and high CO2 emission factor using pure OPC as binder. At the same time, it has not been clear as to how to develop a new material that has sufficient structural strength that can at the same time have the necessary water barrier properties to be useful in the structure of underground trenches that will also need to serve as water barriers.

In accordance with the present disclosure, a dry mixture of several components has been provided which when added to water becomes a self-hardening slurry that can be delivered to suitable cavities and other locations wherein structures are being constructed that will require sufficient water barrier properties. In certain aspects of the method of obtaining the slurry composition of the disclosure, it is possible to form the slurry in stages wherein certain components are combined with specific components before additional ingredients are added. Alternatively, the present composition may be a stand-alone mixture of ingredients which, when water is added, turn into a self-hardening slurry that will dry in a predictable manner and form a structure with suitable water-barrier properties

In accordance with the present disclosure, it needed to be determined what material or combination of materials would be needed to adequately replace in part the OPC component, but this was difficult because this had not previously been considered, and because it would not have been known how to replace the OPC content and yet maintain the same needed properties including the correct hydraulic permeability.

In this regard, the present inventor developed self-hardening slurries as described herein provide the advantageous engineering properties of strength and hydraulic conductivity or permeability and thus are suitable in particular for the construction of underground water cutoffs and other water barriers designed to achieve a hydraulic conductivity of about 10⁻⁶ or 10⁻⁷ cm per second. In the present self-hardening slurries, materials with a high silica content were used so as to lower the overall level of OPC but maintain the necessary properties with regard to strength and water permeability.

In one exemplary embedment of the SHS of the present disclosure, an aqueous self-hardening slurry is provided that comprises (a) about 5-15% by weight of OPC; (b) about 3-12% by weight of a high-silica material wherein the silica content is in the range of 50-95% of the mass of said high-silica material; (c) about 2-8% by weight of bentonite; and (d) about 75-90% by weight of water. The self-hardening slurry can be prepared in any suitable manner, such as by preparing a dry blend of ingredients and then adding water. In addition, the slurry may be prepared in stages, such as by first adding an amount of bentonite, e.g., between 25 and 75 grams, with an amount of water, e.g., 700 to 900 grams, and mixing over a period of time (e.g., 7-9 hours) until full hydration is achieved. Next, an amount of Portland cement (OPC), e.g, 75 to 125 grams, or 100-120 grams, is blended with the high silica material in amount, e.g., of 40 to 100 grams, and this mixture is mixed into an amount of fresh water, e.g., 100 to 300 grams, and poured into a well dispersed grout, e.g, for 1-5 minutes. The slurry of bentonite obtained above is then also poured into the cement grout under agitation until fully homogenous (e.g., for 2-10 minutes). A viscous self-hardening slurry without any bleed is created under this process in the proportions as set forth above, and after molding and being left to cure for multiple days, e.g., 100-200 days; the self-hardening slurry of the present disclosure will form into a hardened and permanent water barrier with a hydraulic conductivity coefficient with very low permeability that make it suitable for this purpose.

As indicated herein, the high-silica materials used in the self-hardening slurries of the disclosure will generally have a silica content of 40% or higher, and this will generally be between 50% and 95% by mass. As a result, the high silica materials suitable for use in the slurry of the disclosure include but are not limited to a material selected from the group consisting of pumice, perlite ore, expanded perlite, diatomaceous earth, Red Lake earth, bentonite, sodium bentonite, calcium bentonite, kaolin, and attapulgite. The silica in the high-silica material may be of various forms, such as SiO₂. In another suitable example, the high-silica material is bentonite.

The high-silica materials as described herein will be fully understood by those of ordinary skill in the art and will be more readily available than materials used in prior traditional forms using a relatively high amount of OPC. Such materials include pumice, also called pumicite in its powdered or dust form, which is a volcanic rock characterized by vascular and rough-textured volcanic glass. Various forms of perlite may also be used, and perlite is an amorphic volcanic glass that has a relatively high water content and is typically formed by the hydration of obsidian.

Diatomaceous earth is a well know material which is a natural occurring soft siliceous sedimentary rock that can be crumbled into a fine white powder, and Red Lake Earth, also known as Red Lake Earth Diatomaceous earth, is a mixture composed of a natural blend of diatomaceous earth and calcium bentonite. All of the high-silica materials as described herein are thus well known and understood in this field, and their ready availability also makes them ideal for the present slurries as they will generally be more readily available than other materials used in such products.

By virtue of the present self-hardening slurry, a product is provided wherein the amount of OPC used is typically about 11% or less, thus achieving a 50% or greater reduction in OPC from the traditional version which normally contains 22% OPC. The slurry of the present disclosure is advantageous by virtue of the reduction in OPC content alone, but it is also advantageous because of the superior properties with regard to the low water permeability. In exemplary embodiments, the aqueous self-hardening slurry as described herein will have a hydraulic conductivity of about 10⁻⁶ to 10⁻⁷ cm per second.

As a result of providing the aqueous self-hardening slurry as described above, there is also provided a water barrier comprising the aqueous self-hardening slurry material as described herein. This water barrier may be used to form dams, sluices, cutoff walls and a variety of other structures used to provide long-term water barriers with very low permeability to water. Once again, as set forth herein, the water barriers of the present disclosure will have a permeability coefficient of less than 10⁻⁷ cm/sec.

In accordance with the disclosure, an aqueous self-hardening slurry comprising: (a) about 40-60 grams of bentonite per 1000 grams of water; (b) about 40 to 100 grams of a high-silica material per 1000 grams of water wherein the silica content is in the range of 50-95% of the mass of said high-silica material; and (c) about 75 to 125 grams or about 100 to 120 grams of OPC per 1000 grams of water. In certain embodiments, the aqueous self-hardening slurry will have high-silica material in an amount of about 50 to 90 grams per 1000 grams of water. Once again, the aqueous self-hardening slurry of the disclosure may use any high-silica material such as those having a silica contact of from about 50 to 95% by mass, and these materials can include but are not limited to pumice, perlite ore, expanded perlite, diatomaceous earth, Red Lake earth, bentonite, sodium bentonite, calcium bentonite, kaolin, and attapulgite. As referred to above, the slurries of the disclosure will generally contain no more than 11% of OPC and will thus represent a 50% or greater reduction in the amount of OPC needed to provide suitable water barriers as described herein. As also described above, these slurries will maintain very low water permeability, and will have a low hydraulic conductivity of about 10⁻⁶ to 10⁻⁷ cm per second so as to be useful in water barrier applications.

In certain embodiments, a dry blend mixture is provided which is capable of forming a self-hardening mass when reacted with an aqueous component, and such dry blend mixtures may comprise about 40-55% by weight of OPC, about 20-35% by weight of high silica materials wherein the silica content is in the range of 50-95% of the mass of said high-silica materials; and about 20-35% of bentonite. An aqueous self-hardening slurry may then be formed by adding a suitable amount of the dry blend mixture to water.

Still further, an aqueous self-hardening slurry is provided which comprises (a) about 5-12% by weight of OPC; (b) about 2-10% by weight of high-silica materials wherein the silica content is in the range of 50-95% of the mass of said high-silica materials; (c) about 2-10% by weight of bentonite; and (d) about 75-90% by weight of water.

In general, the self-hardening slurries of the disclosure are prepared as an improvement over traditional CB materials that use 22% or higher of Portland Cement. In the present disclosure, an improvement is provided over the traditional aqueous self-hardening slurry comprising OPC of 22% or greater, bentonite, and water wherein the improvement comprises replacing at least 50 percent of the OPC with a high-silica material wherein the silica content is in the range of 50-95% of the mass of said high-silica material.

In another exemplary embodiment of the present disclosure, a method is provided for making a self-hardening slurry or preparing a water barrier comprising adding water to a dry blend mixture is provided which is capable of forming a self-hardening mass when reacted with an aqueous component, and such dry blend mixtures may comprise about 40-55% by weight of OPC, about 20-35% by weight of high silica materials wherein the silica content is in the range of 50-95% of the mass of said high-silica materials; and about 20-35% of bentonite.

A method for preparing an aqueous self-hardening slurry or a water barrier is also provided n aqueous self-hardening slurry may then be formed by adding a suitable amount of water to a composition comprising t (a) about 4-15% by weight of OPC; (b) about 2-15% by weight of high-silica materials wherein the silica content is in the range of 50-95% of the mass of said high-silica materials; and (c) about 2-12% by weight of bentonite; wherein the total amount of water may be about 75-90% by weight of the aqueous slurry. The water barrier may be prepared by pouring the aqueous self-hardening slurry into a suitable enclosure that is set up for form a water barrier and then allowing the aqueous self-hardening slurry to harden in situ.

In still further embodiments of the present disclosure, a method is provided for making an aqueous self-hardening slurry comprising adding water to a composition comprising (a) bentonite in a proportion of about 40-60 grams of bentonite for every 1000 grams of water added; (b) a high silica material in a proportion of about 40 to 100 grams for every 1000 grams of water added, wherein the silica content is in the range of 50-95% of the mass of said high-silica material; and (c) OPC in a proto portion of about 75 to 125 grams for every 1000 grams of water added. In certain embodiments, these above components can be mixed together and then combined with water in order to obtain a self-hardening slurry as described herein. Alternatively, a method is provided wherein the self-hardening material is prepared in stages, for example, by (a) firstly adding water to the bentonite and mixing form a bentonite slurry until full hydration occurs; (b) secondly blending the high silica material is blended with a reduced amount of OPC as described herein and then mixing the blend of OPC and high-silica material with water to form a cement grout; and (c) pouring the bentonite slurry into the cement grout of OPC and high-silica material under agitation until fully homogenous. When poured into a suitable enclosure in situ, the slurry is allowed to harden to form the water barrier as described herein with superior low permeability properties. As referred to above, the high silica material of this method can be selected from the group consisting of pumice, perlite ore, expanded perlite, diatomaceous earth, Red Lake earth, bentonite, sodium bentonite, calcium bentonite, kaolin, and attapulgite.

### EXAMPLES

In accordance with the disclosure, the following examples reflect the preparation of exemplary embodiments of the present composition and method in which significant reductions of Portland Cement are obtained in a self-hardening slurry that still maintains the necessary properties of hydraulic conductivity (e.g., of about 10⁻⁶ or 10⁻⁷ cm per second) so as to be useful in the construction of underground water cutoffs and other water barriers designed to achieve the hydraulic conductivity needed for such applications.

### General Example and Initial Testing

As indicated herein, the present disclosure relates to a self-hardening slurry that has sufficient properties to be used as an effective long-term water barrier, but one that can be constructed using far less OPC. The main advantage of the embodiments of the disclosure is the assurance that low permeability cutoff walls will be constructed in the future when there will likely be a slag cement disappearance. The present self-hardening slurry can thus take advantage of the situation when it is required to use Portland cement as the sole hydraulic binder in that it can significantly reduce the use of OPC by at least 50% in these self-hardening slurries. Another significant advantage in the present disclosure is the huge potential reduction in the carbon footprint of the materials.

As indicated above, the field of this disclosure is in an area of geotechnical construction that uses mixtures combining a lot of water, a clay generally used a suspending agent and a binder, typically a Portland cement or a blend of Portland cement and blast furnace slag cement to form a stable fluid slurry that sets after a certain time hence being known as a self-hardening slurry (SHS). Techniques implementing SHS are hydraulic barriers or cutoff walls constructed by trenching, soil mixing, jet grouting, permeation grouting, vibrating beam thin walls, occasionally cavity backfilling. The two main engineering properties are strength and hydraulic conductivity (permeability).

In accordance with the present disclosure, by modifying the silica content of ingredients going into the cement kiln, substantial strength gain has been achieved.

In concrete, the W/C ratio tends to me minimized for maximum strength and is in the range of 0.5 to 0.35. In SHSs typical W/C is in the range of 5 to 10, 10 to 20 times the water amount. The question was whether at such a level of dilution, the Ca/Si ratio modification would also produce improvements in SHS strength.

As a result, a study was undertaken with regard to the possibility of reducing the amount of OPC in a mix by substituting it by a silica rich element, e.g., materials that were 40%-50% of higher in silica, the aim being research to lower the SHS mix carbon footprint while finding natural sources of siliceous soils materials having a natural low carbon footprint and being economical. Transportation is a significant cost representing often more than the value of the materials in the delivered price. This thus created a need to find a variety of materials that could be accessed within a reasonable distance.

Considering that SHSs are primarily used in one step trenching techniques for cutoff walls intercepting clean water in dams and levees, the hydraulic conductivity target is E 10⁻⁶ cm/sec. To achieve this level of watertightness, a conventional CB mix requires a minimum of 22% of OPC by weight of water; the bentonite content being generally in the range of about 4%.

One goal of the present studies was to achieve at least a 50% reduction in the amount of OPC that needed to be used, e.g., since the traditional level of OPC content in a traditional CB mix was 22%, a reduction of 50% of OPC, or down to 11%, was researched by looking for suitable replacement minerals found within the North American continent. As indicated above, the present inventors determined for the first time that high silica materials, e.g, those materials have about 50-95% in silica content, could be used to substitute for 50% or more of the OPC. A list of some materials having such a high silica (as SiO2) content was created, and as reflected in the table below, included but was not limited to pumice, perlite ore or expanded, diatomaceous earth, Red Lake earth, sodium and calcium bentonite, kaolin, attapulgite. In all of these cases, the silica content was in the range of about 50 to 95% of the mass. By comparison, the OPS and slag cement are 20% and 36% respectively.

As a result of the present design to develop contractions materials useful in water barriers and the like which would have very low water permeability, a number of the materials referred to below were tested for their properties for use as a water barrier. The selected materials were entered in the various test mixes at a dosage reflecting their silica content (not knowing the actual active silica content). To aim at a balanced Ca/Si ratio of 1 a silica addition of 42% of the OPC weight was estimated. This gave replacement factors by weight varying between 51 and 77% of the 100% OPC eliminated (resulting in a weight reduction of the total mix). Contrary to typical contract specifications where test results are given at 28 or 56 days, early information but far from SHS ultimate results, tests for this research were performed at 5 months to a year.

Tests results have identified two classes of materials: one that exhibits dramatic strength gains without exhibiting very low permeabilities, and the other providing permeabilities compatible with hydraulic barriers requirements without major strength gain, all this being compared with the reference basic CB mix with 22% OPC. The results from these tests are presented in Table 1 below.

| | | | | TOTAL | DRY | PEAK | STRAIN | |
|---|---|---|---|---|---|---|---|---|
| | | CURING | WATER | UNIT | UNIT | COMPRESSIVE | @ | HYDRAULIC |
| MIX | SPECIMEN | PERIOD | CONTENT | WGT. | WGT. | STRESS | FAILURE | CONDUCTIVIT [symbol] |
| No. | ID | (days) | (%) | (pcf) | (pcf) | (psi) | (%) | (cm/sec) |
| SIF | Silica Fume | 145 | 425.7 | [symbol] | 13.2 | | | [symbol] E−06 |
| SIF | Silica Fume | 144 | 415.7 | [symbol] | 13.7 | 56 | 1.4 | |
| PUM | Pumice | 149 | 410.5 | [symbol] | 13.9 | | | [symbol] E−06 |
| PUM | Pumice | 146 | 406.4 | 71.1 | 14.0 | [symbol] | 1.2 | |
| PER | [symbol] | 145 | 402.6 | 69.4 | 13.8 | | | [symbol] E−06 |
| PER | [symbol] | 144 | 394.2 | 69.7 | 14.1 | 47 | 1.3 | |
| RLE | Red Lake Earth | 145 | 399.4 | 70.2 | 14.0 | | | [symbol] E−06 |
| RLE | Red Lake Earth | 144 | 394.2 | 70.4 | 14.2 | 53 | 1.3 | |
| DIE | Diatomaceous Earth | 146 | 447.0 | 71.5 | 13.1 | | | [symbol] E−06 |
| DIE | Diatomaceous Earth | 145 | 432.9 | [symbol] | 12.9 | 58 | 1.5 | |
| CAB | Calcium [symbol] | 145 | 397.5 | 70.5 | 14.2 | | | [symbol] E−06 |
| CAB | Calcium [symbol] | 145 | [symbol] | 71.0 | 14.6 | 24 | 1.2 | |
| KAO | Kaolin | 146 | 351.1 | 72.0 | [symbol] | | | [symbol] E−07 |
| KAO | Kaolin | 145 | 344.9 | 72.0 | 16.2 | 22 | 1.1 | |
| KAO | Kaolin | [symbol] | 349.7 | 71.2 | [symbol] | 21 | 1.4 | |
| KAO | Kaolin | 191 | 353.3 | 71.6 | [symbol] | | | [symbol] E−07 |
| KAO | Kaolin | [symbol] | 350.2 | 71.7 | [symbol] | | | [symbol] E−07 |
| KAO | Kaolin | [symbol] | 349.9 | 71.8 | [symbol] | [symbol] | 1.4 | |
| NAB | Non-API [symbol] | 146 | [symbol] | 78.2 | 21.3 | | | [symbol] E−06 |
| NAB | Non-API [symbol] | 143 | [symbol] | 75.5 | 21.9 | 20 | 1.0 | |
| ATT | [symbol] | [symbol] | [symbol] | 70.4 | 14.1 | | | [symbol] E−07 |
| ATT | [symbol] | [symbol] | [symbol] | 70.1 | 14.2 | 17 | 1.5 | |
| MIF | Mixed [symbol] | 140 | 324.4 | 72.8 | 17.2 | | | [symbol] E−07 |
| MIF | Mixed [symbol] | 137 | 319.3 | 72.9 | 17.4 | 59 | 1.5 | |
| MIF | Mixed [symbol] | 179 | 312.1 | 72.3 | 17 [symbol] | 59 | 1.3 | |
| MIF | Mixed [symbol] | 182 | 317.3 | 72.2 | 17.3 | | | [symbol] E−07 |
| MIF | Mixed [symbol] | [symbol] | 319.1 | 72.6 | 17.3 | | | [symbol] E−06 |
| MIF | Mixed [symbol] | [symbol] | 320.1 | 72.5 | 17.3 | 81 | 1.2 | |
| BAB | [symbol] | 149 | 122.0 | 70.3 | 13.5 | | | [symbol] E−07 |
| BAB | [symbol] | 146 | 420.0 | 70.2 | 13.5 | 23 | 1.4 | |
| BAB | [symbol] | 188 | 404.1 | 69.9 | 13.9 | 27 | 1.5 | |
| BAB | [symbol] | 191 | 410.8 | 70.2 | [symbol] | | | [symbol] E−07 |
| BAB | [symbol] | 366 | 417.4 | 70.2 | [symbol] | | | [symbol] E−06 |
| BAB | [symbol] | 366 | 417.9 | 70.5 | [symbol] | 34 | 1.1 | |
| BCB | Baseline CB | 144 | 297.5 | 74.0 | [symbol] | | | [symbol] E−06 |
| BCB | Baseline CB | 144 | [symbol] | 73.2 | [symbol] | 28 | 1.0 | |
| BCB | Baseline CB | 188 | [symbol] | 72.7 | [symbol] | 31 | 0.9 | |
| BCB | Baseline CB | 191 | [symbol] | 73.5 | [symbol] | | | [symbol] E−06 |
| BCB | Baseline CB | 366 | [symbol] | [symbol] | [symbol] | | | [symbol] E−07 |
| BCB | Baseline CB | 366 | [symbol] | 73.4 | [symbol] | 32 | 1.2 | |

[symbol]

indicates data missing or illegible when filed

In the above Table, the reference to mixed fines reflects testing done using perlite ore.

The list of tested materials is far from exhaustive; the present tests results do show that the high water content is not impeding the beneficial addition of silica to an OPC slurry, on the contrary, the differences appear to be quite larger than what has been achieved with concrete. An explanation may be that the hydrates formed may become similar to those of a pozzolanic reaction that takes time to occur but can combine a larger amount of water (which is the case of slag cement).

As a result of the above testing, it was clear that the self-hardening materials of the present disclosure could be used to provide water-barrier materials with far less OPC than in standard conventional materials currently in use, and the present materials of this disclosure exhibit significant strength gain and also obtain the very low levels of permeability needed for the materials to be useful in many applications requiring strong and long-lasting water barriers.

In accordance with the present disclosure, additional testing was conducted with regard to the self-hardening slurries as described herein and exemplified below.

### Example 1 (Baseline Example—Prior Art Traditional CB)

In order to test the properties of the slurry of the present disclosure, a traditional example was prepared using the current amount of OPC. In this prior art example, first 50 grams of bentonite was added to 800 grams of fresh water and mixed until full hydration (8 hours). Second, 220 grams of Portland cement was mixed into 200 grams of fresh water into a well dispersed grout (one minute). Third, the bentonite slurry was poured into the cement grout under agitation until fully homogenous (4 minutes). A viscous self-hardening slurry without any bleed is created and after molding left to cure for 144 days; at that point the hydraulic conductivity coefficient measured under ASTM D 5084 was K=1.3×10⁻⁶ cm/sec. and at 366 days that value went down to K=4.8×10⁻⁷ cm/sec.

### Example 2

In accordance with the present disclosure, a self-hardening slurry material was prepared which obtained a 50% reduction in OPC. In this example, first 50 grams of bentonite was added to 800 grams of fresh water and mixed until full hydration (8 hours). Second, 110 grams of Portland cement was blended with 60.6 grams of Pumice and mixed into 200 grams of fresh water into a well dispersed grout (one minute). Third, the bentonite slurry was poured into the cement grout under agitation until fully homogenous (4 minutes). A viscous self-hardening slurry without any bleed is created and after molding left to cure for 145 days; at that point the hydraulic conductivity coefficient measured under ASTM D 5084 was K=2.1×10⁻⁶ cm/sec.

### Example 3

In another example in accordance with the present disclosure, 50 grams of bentonite was added to 800 grams of fresh water and mixed until full hydration (8 hours). Second, 110 grams of Portland cement was blended with 72.4 grams of Red Lake Earth and mixed into 200 grams of fresh water into a well dispersed grout (one minute). Third, the bentonite slurry was poured into the cement grout under agitation until fully homogenous (4 minutes). A viscous self-hardening slurry without any bleed is created and after molding left to cure for 145 days; at that point the hydraulic conductivity coefficient measured under ASTM D 5084 was K=2.2×10⁻⁶ cm/sec.

### Example 4

First, 50 grams of bentonite was added to 800 grams of fresh water and mixed until full hydration (8 hours). Second, 110 grams of Portland cement was blended with 54.3 grams of Diatomaceous Earth and mixed into 200 grams of fresh water into a well dispersed grout (one minute). Third, the bentonite slurry was poured into the cement grout under agitation until fully homogenous (4 minutes). A viscous self-hardening slurry without any bleed is created and after molding left to cure for 145 days; at that point the hydraulic conductivity coefficient measured under ASTM D 5084 was K=2.7×10⁻⁶ cm/sec.

### Example 5

First, 50 grams of bentonite was added to 800 grams of fresh water and mixed until full hydration (8 hours). Second, 110 grams of Portland cement was blended with 102.3 grams of Kaolin and mixed into 200 grams of fresh water into a well dispersed grout (one minute). Third, the bentonite slurry was poured into the cement grout under agitation until fully homogenous (4 minutes). A viscous self-hardening slurry without any bleed is created and after molding left to cure for 140 days; at that point the hydraulic conductivity coefficient measured under ASTM D 5084 was K=5.8×10⁻⁷ cm/sec., that value going down at 365 days to K=5.0×10⁻⁷ cm/sec.

### Example 6

First, 50 grams of bentonite was added to 800 grams of fresh water and mixed until full hydration (8 hours). Second, 110 grams of Portland cement was blended with 77 grams of Perlite ore and mixed into 200 grams of fresh water into a well dispersed grout (one minute). Third, the bentonite slurry was poured into the cement grout under agitation until fully homogenous (4 minutes). A viscous self-hardening slurry without any bleed is created and after molding left to cure for 140 days; at that point the hydraulic conductivity coefficient measured under ASTM D 5084 was K=3.6×10⁻⁷ cm/sec., that value going down at 365 days to K=4.3×10⁻⁸ cm/sec.

### Example 7

First, 50 grams of bentonite was added to 800 grams of fresh water and mixed until full hydration (8 hours). Second, 110 grams of Portland cement was blended with 64.6 grams of bentonite and mixed into 200 grams of fresh water into a well dispersed grout (one minute). Third, the bentonite slurry was poured into the cement grout under agitation until fully homogenous (4 minutes). A viscous self-hardening slurry without any bleed is created and after molding left to cure for 145 days; at that point the hydraulic conductivity coefficient measured under ASTM D 5084 was K=1.5×10⁻⁷ cm/sec., that value going down at 366 days to K=7.8×10⁻⁸ cm/sec.

### Example 8

The same formulation as prepared in Example 7 was subjected to a filtration test during 8 hours at a pressure of 20 psi representing a hydrostatic head of approximately 46 feet using a modified API filter press apparatus with a 12 inches tall cylinder. This example exhibited a much lower filtrate loss than that of the prior art baseline mix as prepared in Example 1, and provided significant improvement with regard to the overall properties. This comparative test reflected that the self-hardening slurry of the present disclosure can provide a superior product and at the same time permit a huge savings with regard to the materials required to satisfy the complete filling of a cutoff wall trench.

What is claimed is:

1. An aqueous self-hardening slurry comprising:
(a) about 4-15% by weight of OPC;
(b) about 2-15% by weight of a high-silica material wherein the silica content is in the range of 50-95% of the mass of said high-silica material;
(c) about 2-12% by weight of bentonite; and
(d) about 75-90% by weight of water.

2. The aqueous self-hardening slurry according to claim 1 wherein the high-silica material is selected from the group consisting of pumice, perlite ore, expanded perlite, diatomaceous earth, Red Lake earth, bentonite, sodium bentonite, calcium bentonite, kaolin, and attapulgite.

3. The aqueous self-hardening slurry according to claim 1 wherein the silica in the high-silica material is in the form of SiO2.

4. The aqueous self-hardening slurry according to claim 1 wherein the amount of OPC is 11% or less.

5. The aqueous self-hardening slurry according to claim 1 wherein the self-hardening slurry has a hydraulic conductivity of about 10⁻⁶ to 10⁻⁷ cm per second.

6. The aqueous self-hardening slurry according to claim 1 wherein the high-silica material is bentonite.

7. A water barrier comprising the aqueous self-hardening slurry according to claim 1.

8. The water barrier according to claim 7 wherein the water barrier comprises a cutoff wall.

9. The water barrier according to claim 7 wherein the water barrier has a permeability coefficient of less than 10⁻⁷ cm/sec.

10. An aqueous self-hardening slurry comprising:
(a) about 40 to 60 grams of bentonite per 1000 grams of water;
(b) about 40 to 100 grams of a high-silica material per 1000 grams of water wherein the silica content is in the range of 50-95% of the mass of said high-silica material; and
(c) about 75 to 125 grams of OPC per 1000 grams of water.

11. The aqueous self-hardening slurry according to claim 10 wherein the amount of the high-silica material is about 50 to 90 grams per 1000 grams of water.

12. The aqueous self-hardening slurry according to claim 10 wherein the amount of OPC is about 100 to 120 grams per 1000 grams of water.

13. The aqueous self-hardening slurry according to claim 10 wherein the high-silica material is selected from the group consisting of pumice, perlite ore, expanded perlite, diatomaceous earth, Red Lake earth, bentonite, sodium bentonite, calcium bentonite, kaolin, and attapulgite.

14. The aqueous self-hardening slurry according to claim 10 wherein the amount of OPC is 11% or less.

15. The aqueous self-hardening slurry according to claim 10 wherein the self-hardening slurry has a hydraulic conductivity of about 10⁻⁶ to 10⁻⁷ cm per second.

16. A dry blend mixture capable of forming a self-hardening mass when reacted with an aqueous component comprising about 40-55% by weight of OPC, about 20-35% by weight of high silica materials wherein the silica content is in the range of 50-95% of the mass of said high-silica materials; and about 20-35% of bentonite.

17. An aqueous self-hardening slurry comprising water and the dry blend mixture of claim 16.

18. The aqueous self-hardening slurry according to claim 17 wherein the amount of OPC is 11% or less.

19. A method of making a self-hardening slurry comprising adding water to the dry blend mixture according to claim 16.

20. An aqueous self-hardening slurry comprising:
(a) about 5-12% by weight of OPC;
(b) about 3-10% by weight of high-silica materials wherein the silica content is in the range of 50-95% of the mass of said high-silica materials;
(c) about 3-10% by weight of bentonite; and
(d) about 75-90% by weight of water.

21. In an aqueous self-hardening slurry comprising OPC, bentonite, and water, wherein the OPC content is 22% or greater by weight, the improvement comprising replacing at least 50 percent of the OPC with a high-silica material wherein the silica content is in the range of 50-95% of the mass of said high-silica material.

22. A method of making an aqueous self-hardening slurry comprising adding water to a composition comprising:
(a) bentonite in a proportion of about 40-60 grams of bentonite for every 1000 grams of water added;
(b) a high silica material in a proportion of about 40 to 100 grams for every 1000 grams of water added, wherein the silica content is in the range of 50-95% of the mass of said high-silica material; and
(c) OPC in a proportion of about 75 to 125 grams for every 1000 grams of water added.

23. The method of claim 22 wherein:
(a) water is first added to the bentonite and mixed to form a slurry until full hydration occurs;
(b) the high silica material is blended with the OPC and mixed with water to form a cement grout; and
(c) the bentonite slurry is poured into the cement grout under agitation until fully homogenous.

24. The method of claim 22 wherein the high silica material is selected from the group consisting of pumice, perlite ore, expanded perlite, diatomaceous earth, Red Lake earth, bentonite, sodium bentonite, calcium bentonite, kaolin, and attapulgite.

25. A method of preparing a water barrier comprising:
(a) obtaining the aqueous self-hardening slurry according to claim 1; and
(b) pouring the aqueous self-hardening slurry obtained in (a) into an enclosure wherein the aqueous self-hardening slurry will harden and form the water barrier.
